(19) United States
(12) Patent Application Publication
(10) Pub. No.: US 2019/0051098 A1
(43) Pub. Date: Feb. 14, 2019

(54) METHOD AND SYSTEM FOR DISTRIBUTING GAME PIECES

(71) Applicant: AGS LLC, Las Vegas, NV (US)

(72) Inventors: Tan Tran, Tucker, GA (US); Anil Kumar Narra, Alpharetta, GA (US)

(21) Appl. No.: 15/673,080

(22) Filed: Aug. 9, 2017

(51) Int. Cl. G07F 17/32

(52) U.S. Cl. CPC G07F 17/329; G07F 17/3223; G07F 17/3246; G07F 17/3225

(57) ABSTRACT

A method and system are provided for generating and distributing game pieces, such as game pieces which are associated with a secondary event such a raffle, to underlying game play. In one embodiment, an eligible game piece may be won by a player when the player is playing an eligible gaming machine and receives a qualifying outcome as part of playing a wager-based game at the gaming machine. Eligible game pieces and eligible gaming machines may be determined, and thus vary, at each of a plurality of distribution periods during the secondary event.

### FIELD OF THE INVENTION

The present invention relates to methods of presenting and playing games and gaming machines and system which are configured to present games.

### BACKGROUND OF THE INVENTION

Many games involve the generation and distribution of game pieces. Players may collect these game pieces as part of playing the game.

As one example, merchants often present promotional games to their players. The players may be given a printed game board and then attempt to collect printed game pieces which define winning outcomes relative to their game board. For example, the players might be given game pieces when they make purchases with the merchant.

Existing games like these suffer from several drawbacks. One drawback or problem relates to the generation and distribution of the game pieces. As one example, the game pieces may simply be printed and then given to the customers or players. In some cases, certain winning outcomes (such as the most valuable prizes) may only be achieved by obtaining certain rare or scarce game pieces (e.g. the game may be played where large numbers of certain game pieces are available and very few of other game pieces may be available). These rare game pieces might be distributed very early in the game, resulting in the award of the largest prizes right at the beginning of the game, thus substantially decreasing the excitement for other players to continue to play the game.

In other instances, game pieces may be awarded based upon certain qualifying criteria, such as the purchase of a certain product from the merchant. In this case, if a large number of players are interested in playing the game, many players might make qualifying purchases as soon as the game opens, thus substantially decreasing the quantity of game pieces available for the remainder of the game—which may still last for a long period of time.

These and similar issues can be exacerbated when applied to situations where game pieces are awarded in association with the play of gaming machines, such as in association with wagering games played via such gaming machines. As one example, a casino may offer a promotion in which players attempt to collect combinations of game pieces which are awarded to the player based upon their game play. In this case, if a large number of players play the gaming machines early in the promotion, essentially all of the game pieces may be distributed or exhausted very quickly and well before the promotion is over (thus decreasing the desire of the players to continue to play the gaming machines towards the end of the promotion). In other instances, the game pieces might only be awarded when certain game outcomes are achieved. In this instance, it is possible that the game piece triggering outcomes might be irregularly received—such as in a case where essentially few triggering outcomes are received at the beginning of the game. In this case, player interest may win because the players believe that they can't obtain the game pieces, or few of the game pieces may actually be distributed because the required criteria are not received.

Thus, what is needed is a technical solution to the existing problems associated with game piece generation and distribution, and preferably such a solution which is simple to implement, such as by being automatable.

### SUMMARY OF THE INVENTION

Embodiments of the invention comprise methods of generating and distributing game pieces, and gaming machines and gaming systems for implementing the methods.

In one embodiment, the game pieces are associated with a secondary event, such as a raffle-type event. The game pieces may be won based upon play of underlying base wagering games.

In one embodiment, a player may win a designated game piece if the player is playing an eligible gaming machine and receives a qualifying game outcome for the designated game piece at that gaming machine.

In one embodiment, the secondary event is divided in to a plurality of distribution periods. In one embodiment, the game pieces which are eligible to be won and the gaming machines at which those game pieces may be won, are determined at each of the distribution periods during the secondary event. In one embodiment, the game pieces which are eligible to be won and the number of eligible gaming machines during each distribution period depends, in part, upon events during prior distribution periods.

One embodiment of the invention comprises a gaming system comprising a plurality of gaming machines and at least one game server. The system may include other components, such as information or event displays.

In one embodiment, each gaming machine comprises a monetary funds accepting mechanism for accepting monetary funds in creating a player credit balance, at least one display device, at least one player input device, a memory device, a controller, and machine-readable code stored in the memory device executable by the controller to, in response to a wager placed by the player from the player credit balance, cause the at least one display device to present at least one wager-based game.

The at least one game server comprises a processor configured to execute machine readable code, at least one communication interface which permits the game server to transmit information to the plurality of gaming machines and to receive information from the plurality of gaming machines and machine readable code executable by the processor configured to cause the game server to, relative to a secondary event in which game pieces may be won during a secondary event period which is divided into a plurality of distribution periods: a) determine a number of game pieces from a set of game pieces for the secondary event, less any game pieces that were previously awarded, to be made available for winning during a distribution period, each of the number of game pieces having a qualifying wager-based game criteria for winning the game piece; b) determine a number of the plurality of gaming machines at which the number of game pieces may be won during the distribution period; c) determine if the qualifying wager-based game criteria for each of the number of game pieces has been achieved at one of the number of plurality of gaming machines during the distribution period and, if so, awarding the game piece to the player of the gaming machine at which the game piece was won; and d) repeating steps a)-c) for each distribution period or until no game pieces in the set of game pieces remain available for winning.

Further objects, features, and advantages of the present invention over the prior art will become apparent from the detailed description of the drawings which follows, when considered with the attached figures.

### DESCRIPTION OF THE DRAWINGS

FIG. 1 schematically illustrates one embodiment of a system of the invention;

FIG. 2 illustrates one embodiment of a gaming machine of the invention;

FIGS. 3 and 4 illustrate graphical user interfaces in accordance with embodiments of the invention; and

FIG. 5 is a flow diagram of a method of generating and distributing game pieces in accordance with an embodiment of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise methods of generating and distributing game pieces, and gaming machines and gaming systems for implementing the methods. In a preferred embodiment, the methods of game play and presentation are implemented via a gaming system which includes multiple gaming machines.

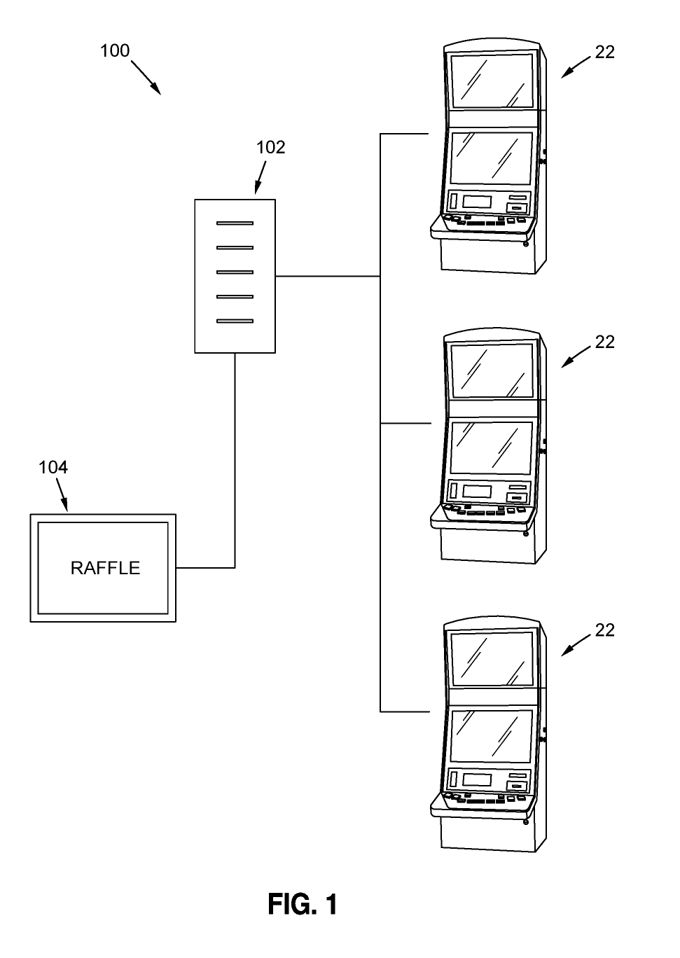

One example of a system 100 of the invention is illustrated in FIG. 1. As illustrated, the system 100 may comprise a game server 102, one or more gaming machines 22 or other player terminals or presentation devices, and one or more information displays 104.

The game server 102 preferably comprises a computing-type device. For example, the game server 102 may comprise one or more processors, at least one communication device or interface, and may include one or more memory or data storage devices. In one or more embodiments, the processor(s) is configured to execute one or more instructions, such as in the form of machine readable code (i.e. “software”), to allow the game server 102 to perform the functions herein. The software is preferably non-transitory, such as by being fixed in a tangible medium. For example, the software may be stored in the one or more memory devices. One or more of the memory devices may be read-only. In addition, the software may be stored on a removable medium in some embodiments. In general, the one or more memory devices are used as temporary storage. For example, the one or more memory devices may be random access memory or cache memory used to temporarily store some user information and/or instructions for execution by the at least one processor.

The software may comprise one or more modules or blocks of machine readable code. Each module may be configured to implement particular functionality when executed by the one or more processors, and the various modules may work together to provide overall integrated functionality. Of course, in certain embodiments, it is also possible for various of the functionality to be implemented as hardware, i.e. a processor or chip which is particularly designed to implement various of the functionality described herein.

In one embodiment, the game server 102 may include one or more input and/or output devices, such as a keyboard, mouse, touchscreen, video display or the like, whereby the processor may receive information from an operator of the game server 102 and/or output information thereto. This allows, for example, an operator of the game server 102 to interface with the game server 102 to upgrade, maintain, monitor, etc., the server. In other embodiments, such a user might interface with the game server 102 via a separate workstation or other device.

The communication devices or interfaces permit the game server 102 to communicate with external devices, networks, systems and the like. As one example, as illustrated in FIG. 1, the game server 102 may communicate with the gaming machines 22 and the one or more displays 104. The communication interface may permit data to be exchanged between the game server 102 and the gaming machines 22 and information displays 104 via one or more communication paths or links (which paths may include WANs, LANS, public or private networks, the Internet, cellular telephone networks or the like). The communication devices 124 may be capable of utilizing various communication protocols, such as TCP/IP or proprietary gaming protocols such as SAS, S2S, G2S or the like, and to communicate with a wide variety of other devices, and may communicate over wired and/or wireless links.

In one embodiment, the processor and other elements of the game server 102 may be linked and thus communicate, such as via a communication bus. In this manner, for example, the processor may read/receive software from the memory for execution, receive inputs and provide outputs to the various I/O devices, receive information from or output information to the communication interface, etc.

The game server 102 may be a multi-function server which is configured to perform additional functionality other than that described herein. Further, the game server 102 might include devices or elements other than those described herein.

In one embodiment, the information display 104 comprises a video display, such as an LCD, LED, OLED, DLP or other type of display now known or later developed. The information display 104 may include a communication interface for receiving information from the game server 102 (and, in some instances, for communicating information to the server), a video controller or other components or elements which are well known.

The system 100 may include a single information display 104 or multiple displays. The displays 104 might be dedicated displays or might be configured to display a wide variety of information other than the information disclosed herein, including by being associated with other devices or systems. For example, the information display 104 might comprise a dedicated wall-mounted display or it might comprise a display which is located at a bank of gaming machines, wherein the information display 104 is primarily used to display only information and is not part of another device. However, as another example, the information display 104 might comprise a secondary or tertiary display which is part of a gaming machine 22.

The gaming machines 22 or player terminals may have various configurations. The gaming machines 22 may be located at a casino (and as such may be referred to as a “casino gaming machine”).

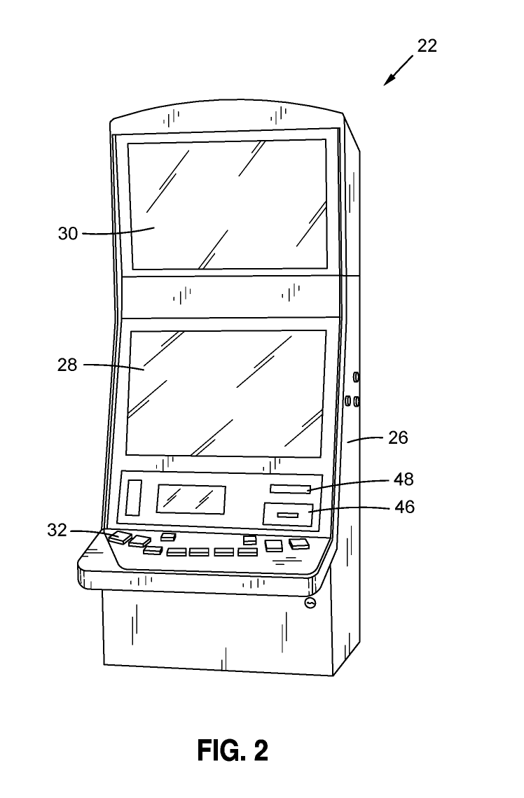

One configuration of a gaming machine 22 is illustrated in FIG. 2. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. The gaming machine 22 might include more than one display device 28, such as two or more displays 28 which are associated with the housing 26. The gaming machine 22 might also include a top box or other portion. Such a top box might include one or more display devices 30, such as in addition to one or more main displays which are associated with the housing 26. Also, the gaming machine 22 might include side displays (such as mounted to the exterior of the housing 26) and might include multiple displays of differing sizes.

While the display devices may comprise one or more video displays, (such as for presenting video poker, video slots or other video-based games) in another embodiment, the gaming machine 22 may include one or more physical reels capable of displaying game information, such as slot symbols. In such a configuration, means are provided for rotating the physical reels. In one or more embodiments, the means may comprise a mechanical linkage associated with a spin arm, with movement of the spin arm (a “pull”) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. The principal of such an arrangement is described in U.S. Pat. No. 4,448,419 to Telnaes, which is incorporated herein by reference.

As described in more detail below, the gaming machine 22 is preferably configured to present one or more games upon a player making a monetary payment or wager. In this regard, as described in more detail below, the gaming machine 22 includes a mechanism or means for accepting monetary value.

In one embodiment, certain game outcomes (but preferably not all game outcomes) may be designated as winning outcomes (the non-winning outcomes may be referred to as losing outcomes). Prizes or awards may be provided for winning outcomes, such as monetary payments (or representations thereof, such as prize of credits), or promotional awards as detailed herein. As detailed below, the gaming machine 22 preferably includes a mechanism or means for returning unused monetary funds and/or dispensing winnings to a player.

The gaming machine 22 preferably includes one or more player input devices 32 (such as input buttons, plunger mechanisms, a touch-screen display, joystick, touch-pad or the like). These one or more devices 32 may be utilized by the player to facilitate game play, such as by providing input or instruction to the gaming machine 22. For example, such input devices 32 may be utilized by a player to place a wager, cause the gaming machine 22 to initiate a game, to “cash out” of the gaming machine, or to provide various other inputs.

In one preferred embodiment, the gaming machine 22 includes at least one microprocessor or controller for controlling the gaming machine, including receiving player input and sending output signals for controlling the various components or peripheral devices of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28, for determining winning or losing game outcomes and for displaying information regarding awards for winning game outcomes, among other things.

The controller may be configured to execute machine readable code or “software” or otherwise process information, such as obtained from a remote server. Software or other instructions may be stored at a memory or data storage device, e.g. in a fixed or non-transitory configuration. The memory may also store other information or data, such as data stored in table or other forms (including, but not limited to look-up tables, pay tables and other information, including tracked game play information). The gaming machine 22 may also include one or more random number generators for generating random numbers (such as implemented by a random number generator software module stored in the memory and executable by the processor or controller), such as for use in selecting slot symbols, cards or other game symbols and for presenting the game in a random fashion (e.g. whereby the game is presented in a manner in which the player cannot control the outcome) or pseudo-random fashion (e.g. such as where the game includes a skill component which can affect the outcome of the game).

Preferably, the controller is configured to execute machine readable code or instructions (e.g. software) which are configured to implement the game. In this regard, the gaming machine is specially configured to present the game of the invention via specific software and/or hardware which causes the gaming machine to operate uniquely. For example, the controller of the gaming machine 22 may be configured to detect a wager, such as a signal from a player's depressing of the “bet one” button (such as one of the buttons 32). Upon such an event and/or the player otherwise signaling the gaming machine to present the game, the controller may be configured to cause the at least one display 28 to display unique information, such as a unique graphical interface or unique game display, including game symbols or other game information (such as graphically represented images of cards, slot symbols, dice, etc.). The controller may accept input from a player of game inputs, such as a request to spin reels or the like, via the one or more player input devices of the gaming machine 22. As indicated above, the machine-readable code may be configured in various manners, such as by having various “modules” of software which are designed to implement specific features of the game play or game presentation.

The gaming machine 22 may be configured to generate and present games in a stand-alone manner or it may be in communication with one or more external devices at one or more times. For example, the gaming machine 22 may be configured as a server based device and obtain game code or game outcome information from a remote game server (in which event the gaming machine controller may receive game information from the server, such as game outcome information, and use that server-generated information to present the game at the gaming machine). For example, the gaming machine 22 might be configured as a stand-alone device or as a server-based device for presenting games as Class III games (as defined by the U.S. Indian Gaming Regulatory Act) or as a server-based device for presenting games as Class II games (as defined by the U.S. Indian Gaming Regulatory Act).

As indicated, the gaming machine 22 is configured to present one or more wagering games. The gaming machines 22 is preferably configured to accept value, such as in the form of coins, tokens, paper currency or other elements or devices representing value such as monetary funds. Thus, as indicated above, the gaming machine 22 preferably includes a mechanism or means for accepting monetary value. For example, as illustrated in FIG. 2, the gaming machine 22 might include a coin acceptor 32 for accepting coins. Of course, associated coin reading/verifying devices and coin storage devices may be associated with the gaming machine 22 if it is configured to accept coins. Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOB s, magnetic stripe cards or other media having data associated therewith and via which value or funds may be associated with the gaming machine 22. The mechanism for accepting monetary value might also comprise hardware and/or software which allows a player to transfer (such as electronically) funds from an account, such as a casino wagering account, or a bank or other financial institution account. Such a mechanism might include a communication interface which permits the gaming machine to communicate with a mobile phone, PDA, tablet or other electronic device of the player (such as via a physical interface or wired or wireless communications links, such as to enable the transfer of funds from the player to the gaming machine or system).

When the player associates funds with the gaming machine or an associated system, a credit balance is generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). In one embodiment, when the player's wager is received, the player's credit balance is reduced by the number of wagered credits. The player might then provide a separate input to begin the game. In other embodiment, the player might select a “play game” input, such as by pressing a “spin” button, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming machine 22 to indicate their desire to cash out, such as by selecting a “cash out” button (such as implemented via one of the buttons 32) or touch screen feature or providing other input. In response, a monetary value represented by the player's credit balance or the like is preferably paid, transferred or otherwise provided to the player. For example, upon an award or at cash-out, associated funds may be paid to the player by the gaming machine 22 dispensing coins to a coin tray. In another embodiment, funds may be issued by dispensing paper currency or other media. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference. In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. In other embodiments, the cash-out mechanism may result in the funds value being transferred to an external device or account, such as a player's casino account (such as associated with a casino server), a remote bank or other financial account, or an electronic device such as a player's phone, PDA or tablet.

The gaming machine 22 may also include a player tracking device, such as a card reader 46 and associated keypad 48 (and where information read from a player card presented to the reader and a player PIN provided to the keypad, may be used to identify a player and track their activities at the gaming machine, such as in conjunction with a back-end player tracking system which may include a player tracking server). Such player tracking devices are well known and may permit the game operator to track play of players of the gaming machine. The tracked play may be utilized to offer player bonuses or awards.

A casino may have numerous such gaming machines 22, such as located on a casino floor or in other locations. Of course, such gaming machines 22 might be used in other environments, such as an airport, a bar or tavern or other locations.

It will be appreciated that the gaming machine illustrated in FIG. 2 is only exemplary of one embodiment of a gaming machine. For example, it is possible to for the gaming machine to have various other configurations, including different shapes and styles and having different components than as just described.

For example, instead of comprising a “casino”-style gaming machine, it is possible for aspects of the invention to be implemented relative to a computing device, including at a home or office computer or a player's mobile electronic device such as a PDA, phone or the like. In one embodiment, a player might log in to a casino server and the controller of the casino server may cause game information to be delivered to the player's computer via a communication link and then be displayed on a display of the player's computer. The communication link might comprise or include the Internet, a casino network such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a gaming machine or a player's computer or other electronic device. The local controller at the gaming machine or the player's computer or other electronic device may then cause game information to be displayed on one or more associated displays.

It is noted that the system 100 illustrated in FIG. 1 may include other devices. For example, the system 100 (and gaming machines 22) might include or be communicatively linked to a player tracking server or system, an accounting system or server, a ticketing system, one or more kiosks, table gaming devices, progressive systems or servers, a bonusing system, a tournament system, other gaming machines, and external devices.

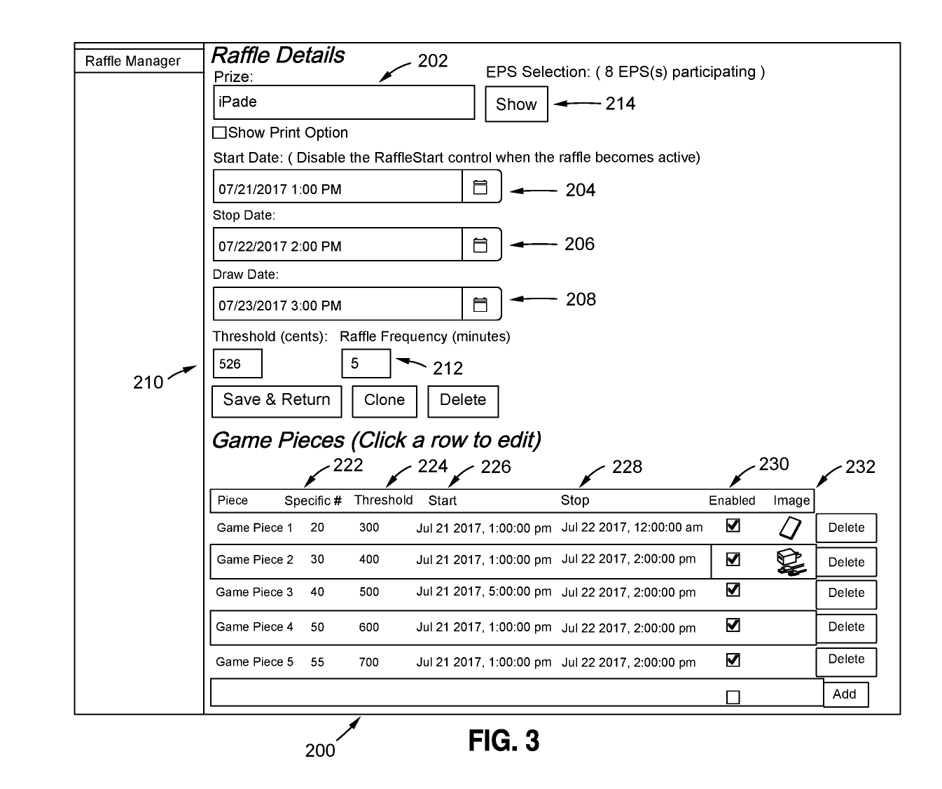

Additional aspects of the invention will be described with reference to FIG. 3. In one embodiment, aspects of the invention comprise methods for generating and distributing game pieces. In a preferred embodiment, game pieces are distributed to players of gaming machines, such as the gaming machines 22 of the system 100 which is described above.

The game pieces may be used in a variety of games or events which may be wager-based or promotional or the like. As one example, a casino might offer a promotional raffle to players of its wager-based gaming machines. The outcome of the event may be determined in various manners. For example, in one preferred embodiment of the invention, the event is a promotional raffle event where players are entered into the raffle if they successfully collect a certain combination of game pieces, such as an entire set of offered game pieces. In one embodiment, the event might be played relative to a game board (or different game boards assigned to each player) and where the players must match the game pieces to the game board (either in certain combination or by matching all of them). In one embodiment, players who achieve the required combination of game pieces may be eligible for an award or a chance for an award. As one example, each player who obtains the entire set of game pieces might be provided with one or more entries into a raffle type event where the winners are randomly selected from the entries into the event.

In one embodiment, the method of generating and distributing game pieces (and thus the event) involves or is based upon multiple parameters. The event may be referred to as a secondary event because it is tied to or implemented relative to base wagering game play. The event may comprise a raffle, but as noted above, the game pieces could be used in other types of events. Some of the parameters for the secondary event may comprise:

(1) The total time for or duration of the event, e.g. the time between a start time/date and an end time/date of the event/raffle during which the game pieces may be distributed.

(2) Total number of games pieces to be distributed. In one embodiment, there are a plurality of different game pieces and the number of each different game piece may vary (such as being as few as 1 of a particular game piece or a large number of a particular game piece; as one example, the event might be played with 20 of game piece A, 50 of game piece B, 5 of game piece C and 500 of game piece D).

(3) A distribution period or frequency: This is a frequency at which gaming machine eligibility and game piece availability are determined. This may be referred to as the “raffle frequency.” As described in more detail below, in one embodiment the total time of the event/raffle is broken up into periods of time and during each period of time, a determination is made as to particular game pieces which are available to be won and particular gaming machines at which the game pieces may be won, wherein these parameters may be adjusted and thus be different during each distribution period.

(4) A game piece eligibility. In one embodiment, one or more criteria must be met in order for a player to win a game piece. In a preferred embodiment, the criteria may be a value or amount which must be won (such as via a winning game outcome of a wagering game presented to a player of a gaming machine) in order for the player to win the game piece (as noted below, the game piece is still only awarded if the gaming machine at which the threshold is achieved, it is eligible. In one embodiment, a default or base eligibility may be set or applied to the game pieces, where that base eligibility may be modified to a game piece specific eligibility requirement.

(5) One or more game piece parameters. The parameters may include one or more of: (A) a weighting which is applied to game pieces based on remaining time left to distribute the balance of the game pieces with in the remaining raffle/event time; (B) the number of game pieces available; and (C) game piece eligibility.

(6) Gaming machine eligibility. This may comprise a number of gaming machines which are eligible to have a game piece distributed to them (assuming a game piece is available to be won and the game piece eligibility has been met). In one embodiment, this is determined based upon an average number of game plays that generate winning outcomes over the game piece eligibility.

In one embodiment, the system operator may view and/or modify various of the event parameters, such as via one or more graphical user interfaces which are displayed on a display associated with the game server 102 (and by providing input to the game server 102, such as via a touch screen, mouse, keyboard or other input device). One example of such an interface is illustrated in FIG. 3.

As illustrated in FIG. 3, such an interface 200 may include an option for selecting or designating one or more prizes or awards 202 for winning outcomes of the event. The interface 200 may also include an option for selecting a start date/time 204 for the event (at which time game pieces may begin to be distributed), an end date/time 206 for the event (at which time the game pieces would no longer be distributed), and a draw time 208 for the event (at which time the outcome of the event is determined). The interface 200 may also include an option for selecting a base game piece threshold eligibility 210. In one embodiment, this might comprise a minimum game win value, such as a monetary value or number of monetary value credits which comprise a minimum win value, which must be received as the result of a gaming winning outcome. The interface 200 may also include an option for selecting the distribution period or “raffle frequency” 212. This may comprise an interim of time, such as a number of minutes, hours or the like.

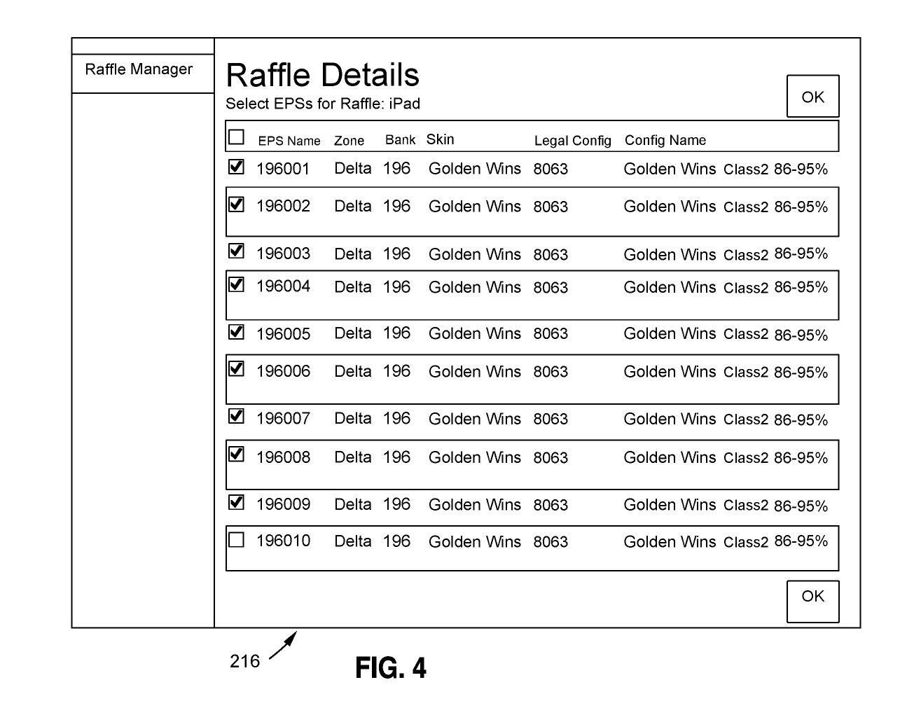

As illustrated, the interface may also include an option 214 for selecting a group or set of gaming machines, e.g. for selecting particular machines which are part of the event (it being understood, as described in more detail herein, that at any given time, only certain of those gaming machines may be eligible to have a game piece distributed to them). In one embodiment, as illustrated, selecting this option might cause a new interface 216 to open or be displayed, as illustrated in FIG. 4, which provides details regarding the available gaming machines which may be selected (and their status, etc.)

In one embodiment, the one or more interfaces 200 may also include options which allow the operator to set or modify parameters relating to the game pieces. For example, as illustrated in FIG. 3, these options might comprise a name of each game piece 220, a number of each game piece which is available in the event 222, game piece eligibility for each game piece 224 (in one embodiment, each game piece may have its own separate or unique eligibility requirement, such as a minimum game win value, wherein the base eligibility may be utilized as a default and might then be overridden to comprise a game piece specific eligibility requirement. The one or more interfaces 200 might also include the option to set a start time 226 when a particular game piece becomes eligible for distribution and a stop time 228 when a particular game piece no longer is eligible for distribution (wherein the start and stop times 226, 228 are within the overall time period for the event/raffle), an enable option 230 which determines whether a particular game piece is utilized in the particular event/raffle. In one or more embodiments, the one or more interfaces 200 may also display an image 232 of each different game piece.

Of course, the one or more interfaces 200 might have other configurations, including to display or include other information. For example, instead of a start time and end time for the event and a game piece, the interface 200 might allow the operator to select a start time and then a duration which extends from that start time.

In general, in accordance with the invention, during the event (such as the raffle), game pieces are made available to be won by players. Players attempt to win, and thus collect, the game pieces. As noted herein, if a player obtains certain game pieces or combinations of game pieces, the player may win an award or be eligible to win an award (such as based upon the outcome of a raffle selection).

In one embodiment, game pieces may only be won at designated machines, and only then if the game piece eligibility requirement for that game piece is met at one of those designated gaming machines (such as by a player of one of the designated gaming machines receiving a game winning outcome which has an associated award which meets the eligibility requirement for the game piece).

In one embodiment, the one or more game pieces which are eligible to be won (if the eligibility requirement for that game piece is met) and the gaming machines at which a game piece may be won, is determined and may vary during each distribution period during the event/raffle. In one embodiment, one or more automated methods or algorithms are utilized to generate and distribute game pieces. Preferably, the algorithm is implemented as software which is executed by the game server 102. As noted herein, the methods or algorithms may be configured to address shortcomings of the prior art and achieve certain desired benefits.

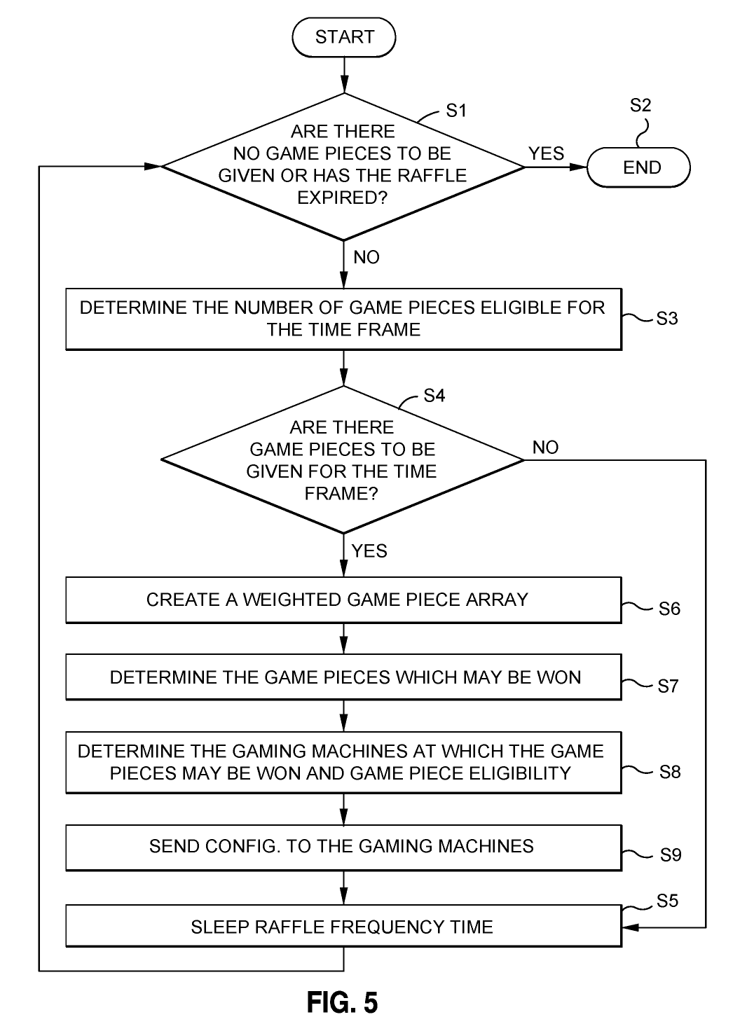

One embodiment of such a method will be described with reference to FIG. 5. FIG. 5 illustrates a process which may be initiated when the event/raffle starts (such as at its start time). In a step S1, it may be determined whether there are any remaining game pieces to be distributed or whether the event time has expired. Of course, there would be remaining game pieces to distribute at the beginning of the event. However, at some point during the event and before the end time, it is possible that all game pieces could have been distributed. If that has occurred or the end time of the event has been reached, then the process of distributing game pieces ends as at step S2. In one embodiment, at that point or at the draw date, the outcome of the event may be determined.

If the event has not ended and there are game pieces to be distributed, then game piece eligibility is determined, as at step S3. Preferably, at this step, the number of game pieces which are eligible to be distributed within the distribution period is determined.

In one embodiment, step S3 comprises one or more of the following steps. The total number of available game pieces for the entire event/raffle is determined. The number of game pieces that may be distributed during a distribution period is then determined, such as by dividing the number of game pieces by the total time (e.g. the time between the event start time and event end time) by the distribution frequency. For example, if the total event time is 1 hour and the distribution frequency is 5 minutes, then there are 12 distribution periods of 5 minutes each. If there are 120 total game pieces to be distributed during the event, then 10 game pieces would be the base calculated number of game pieces for distribution during each distribution period (although as noted below, this number might vary in later distribution periods, such as if fewer than desired numbers of game pieces are awarded during earlier distribution periods).

In a step S4, it is determined if there are game pieces to be distributed during the distribution period. If not, then the process may proceed to step S5, where the process sleeps until the end of that distribution period (and then begins again at the beginning of the next distribution period). If so, then in a step S6, the one or more game pieces which are to be made available for distribution or winning during that distribution period may be determined.

Step S6 may comprise one or more of the following steps. In one embodiment, a weighting is applied to the game pieces. The weighting may be applied to each game piece based upon the available opportunities to give it out. This may be determined by determining the game piece minutes remaining (e.g. the time remaining during which the particular game piece may still be distributed before the end time for distributing that game piece), by comparing that time period to the remaining time period in the event/raffle, and applying a higher weighting to game pieces that have the lowest ratio (least remaining time). For example, assume there is 30 minutes left in the event, there are 30 of game piece A and 30 of game piece B remaining to be distributed, and the distribution period (raffle frequency) is 10 minutes, where the time period for distributing game piece A expires in 20 minutes, while the time period to distribute game piece B expires at the end of the event. In that event, to obtain an equal distribution of game pieces per distribution period, game piece A would be weighted 3 times higher than game piece B for the next two distribution periods (and game piece A would not be available in the final distribution period).

Next, based upon the assigned weighting, an array of the game pieces which are available for the particular distribution period may be generated. In the example above, during the next distribution period an array might be created with 15 of game piece A and 5 of game piece B or another configuring reflecting the weighting of 3:1.

In a step S7, the one or more game pieces which are to be made available for distribution are selected. In one embodiment, the game pieces are selected from the generated array or other matrix, list, etc. of game pieces. For example, when an array of game pieces is generated, each position of the array may be assigned a number. Then a random number may be generated (such as from the number of positions in the array). The game piece corresponding to the selected array position (e.g. corresponding to the particular random number) is then made available for distribution. For example, the array might have 20 positions corresponding to 20 game pieces, wherein the first 15 positions are filled with or correspond to game piece A and the remaining 5 position are filled with or correspond to game piece B. A random number between 1 and 20 is generated, such as 9. In this case, position 9 corresponds to game piece A, such that one of game piece A is made available for distribution (e.g. is made available for winning). Of course, if more than one game piece is made available during a distribution period, this process may be repeated in order to select more than one game piece.

In a step S8, even when a game piece is made available for distribution that game piece is only awarded or won when the eligibility requirement is met for that game piece (such as by receiving a game win of a certain minimum value or award) at an eligible or designated gaming machine. Thus, in accordance with this step, the particular gaming machines at which players may win the game piece are selected or determined. In one embodiment, this comprises selecting a number of gaming machines from the entire set of possible gaming machines at which the game piece is eligible to be won (in some cases, all of the possible gaming machines could be selected, but in most instances a subset of all possible gaming machines is selected).

In one embodiment, this step involves determining a number of gaming machines at which game pieces may be won during the particular distribution period. This may comprise determining the historical frequency of game wins having values over the eligibility requirement (for the particular game piece) at the machines. That qualifying game win frequency may be scaled to the raffle frequency in order to determine the number of gaming machine which must be selected to, on average, result in a sufficient number of qualifying game wins during the distribution period to result in the award of the game pieces. For example, assume that the raffle frequency is 5 minutes and that, on average, each gaming machine generates a qualifying win once per hour. In that event, 12 machines must be selected in order to generate, on average, at least one win in a particular 5 minute distribution period. Thus, if one game piece is to be awarded during the 5 minute distribution period, 12 machines would need to be selected (so that on average, at least one of those machines would generate a game piece winning outcome during the 5 minute period). Next, the number of gaming machines at which the game piece may be won are enabled, such as by selecting them randomly from the set of possible gaming machines. In the above example, assuming that 60 gaming machines are in the set of possible gaming machines, 12 of them could be selected at random (or based upon other criteria). In one embodiment, a predictor-corrector model may be applied to this process, such as by use of a multiplier value, to the game eligible win probabilities (e.g. the game eligible win probability may be predicted and then, based upon actual data, may be modified during each later distribution period, such as by applying a multiplier or corrector value, to generate a better probability value which is used during each distribution period).

In a step S9, the game server may send event/raffle configuration information to the selected or designated gaming machines for the particular distribution period. For example, the server may transmit event information to the selected gaming machine regarding the game piece(s) to be awarded and the threshold eligibility requirements, etc.

If a player of one of the selected gaming machines receives a qualifying game outcome at one of the selected gaming machines during the distribution period, that player is then awarded the designated game piece.

As indicated above, this process preferably repeats during the event/raffle between the event/raffle start time and end time, at each distribution period. For example, if the event lasts 3 days and the event/raffle frequency is 1 hour, the above process begins at the start time and is repeated each hour for the 3 days.

Additional aspects of the invention will now be described.

Aspects of the invention comprise the generation and distribution of game pieces. As noted herein, the method may be implemented relative to an event where a player attempts to collect a set of game pieces which qualifies them for an award, or a chance to win an award. In one embodiment, the event is a raffle where players who collect or win a designated combination or set of game pieces are then granted one or more entries in a raffle, and wherein one or more winners of that raffle may be awarded an award (and where even if a player has collected all of the required game pieces, the player might lose the raffle). As noted, the raffle might comprise the drawing of one or more entries, tickets or like which correspond to qualifying players.

Of course, the method of game piece generation and distribution herein might apply to a wide variety of other events, whether such comprise promotional events, games or the like. Further, the awards or prizes for such an event may vary and might comprise one or more of monies, monetary value credits, tangible goods, discounts, services, etc. In some embodiments, players might be eligible to participate in the secondary event (and thus win game pieces) without being required to place a wager, while in other instances, a player might be required to pay an entry fee or place a wager to participate in the event.

As noted, in one embodiment the method of the invention is implemented relative to a plurality of gaming machines where game piece award eligibility is at least partially dependentent upon a qualifying game winning outcome. Of course, other qualifying criteria might be utilized. For example, a player might qualify to win a game piece if they obtain a particular unique game symbol during the play of a game, a particular bonus game result or other game events. For example, in a Class II environment, a player might qualify to win or be awarded a game piece if they achieve a certain pattern of matches on their bingo card. In one embodiment, different eligibility requirements may be applied to different game pieces. For example, game piece A might have an eligibility requirement that a player obtain a game winning outcome having an award of at least 100 credits, while game piece B might have an eligibility requirement that a player receive a “7” slot symbol in the play of a slot game.

It is also noted that it is possible to implement the invention relative to non-wager based games, such as “for free” or entertainment style base games. It is also possible for a player to win or be awarded more than one game piece if the player meets the required criteria for that game piece.

In one embodiment, the game pieces are virtual game pieces and are thus awarded virtually. For example, an awarded game piece may be displayed to a player via the display of their associated gaming machine. In one embodiment, players and their game play may be tracked, such as by use of well-known player tracking systems. Each game piece which is won by a player may be associated with their player tracking account or the like. A player may be permitted to view the game pieces which they have won.

In one embodiment, information about the secondary event (such as a raffle) may be displayed on the information displays (such as the display 104 illustrated in FIG. 1). For example, player may be informed about upcoming events, such as their start times, prizes, and the like. The display(s) might also display information about active events, such as the time remaining in a particular raffle until it closes. In one embodiment, the game server may push information to the display to be displayed. The game server may include a display manager which allows a user to configure the type of information which is provided to the display, timing, etc.

The invention has numerous benefits. Most importantly, eligibility or availability of game pieces to be awarded or won during the event is determined during a plurality of distribution periods which comprise sub-durations of the entire event duration. This allows game piece eligibility to be modified during the event to achieve a controlled distribution of game pieces. For example, in accordance with the invention, game piece distribution can be controlled to prevent all of the available game pieces from being awarded or won at the very beginning of the event (so that few or no game pieces are available towards the end of the event). As noted, in one embodiment, the total number of game pieces which are made available for winning during each distribution period may be controlled and comprise a subset of the total number of game pieces for the entire event.

Also, the distribution of particular game pieces can be controlled, such as to prevent all of one particular game piece from being awarded or won all at once so that it is no longer available during the remainder of the game. As noted above, an array of available game pieces for each distribution period may be generated, wherein the available game pieces may be weighted based upon their relative availability (e.g. the total number of a particular game piece and the time during which that particular game piece is available, as compared to the total number of game pieces and total time for the entire event). Further, game piece availability is modified based upon past events, such as whether or not certain game pieces were won in previous distributions periods. As one example, only two of a certain game piece A may be available during the event and game piece A may only be available for distribution during the last two distribution periods. One of game piece A may be made available for winning in the second to last distribution period. If the game piece is not won (such as because no player received the required game winning outcome), then in accordance with the method, during the next distribution period game piece A would be weighted more heavily to result in the selection of both of game piece A as available for winning in the final distribution period.

The invention has particular advantage when applied to gaming machines and where game piece eligibility and award is tied to game play. In particular, in accordance with the invention, a method is provided wherein the probability of one or more gaming machines yielding an outcome which triggers the award of a game piece is a factor in determining game piece generation and distribution.

One advantage to the invention is that event criteria may be set by the operator and then the methodology may be implemented automatically, thus removing guesswork from the game piece generation and distribution from the process and implementing a process that could not realistically be accomplished manually (due to the complex calculations which are constantly ever changing during the event for each distribution period).

It will be understood that the above described arrangements of apparatus and the method there from are merely illustrative of applications of the principles of this invention and many other embodiments and modifications may be made without departing from the spirit and scope of the invention as defined in the claims.

1. A gaming system comprising:
a plurality of gaming machines, each gaming machine comprising a monetary funds accepting mechanism for accepting monetary funds in creating a player credit balance, at least one display device, at least one player input device, a memory device, a controller, and machine-readable code stored in said memory device executable by said controller to, in response to a wager placed by said player from said player credit balance, cause said at least one display device to present at least one wager-based game;
at least one game server, said at least one game server comprising:
a processor configured to execute machine readable code;
at least one communication interface which permits said game server to transmit information to said plurality of gaming machines and to receive information from said plurality of gaming machines; and
machine readable code executable by said processor configured to cause said game server to, relative to a secondary event in which game pieces may be won during a secondary event period which is divided into a plurality of distribution periods:
a) determine a number of game pieces from a set of game pieces for said secondary event less any game pieces that were previously awarded, to be made available for winning during a distribution period, each of said number of game pieces having a wager-based game eligibility requirement for winning said game piece;
b) determine a number of said plurality of gaming machines at which each of said game pieces may be won during said distribution period, the number of gaming machines at which each of said game pieces may be won being different for at least some of the game pieces;
c) determine if said wager-based game eligibility requirement for each of said number of game pieces has been achieved at one of said number of plurality of gaming machines during said distribution period and, if so, award said game piece to said player of said gaming machine at which said game piece was won; and
d) repeating steps a)-c) for each distribution period or until no game pieces in said set of game pieces remain available for winning.

2. The gaming system in accordance with claim 1, wherein said secondary event comprises a raffle type event in which said game pieces comprise entries into said raffle.

3. The gaming system in accordance with claim 2, wherein one or more raffle type event winners are selected from qualifying players.

4. The gaming system in accordance with claim 3, wherein said set of game pieces comprises one or more of each of a plurality of different game pieces said qualifying players comprise players who have won at least one of each of said plurality of different game pieces.

5. The gaming system in accordance with claim 1, wherein said wager-based game eligibility requirement comprises receipt of a winning wager-based game outcome having a minimum winning award.

6. The gaming system in accordance with claim 1, wherein said distribution periods comprise intervals of time during said secondary event period.

7. The gaming system in accordance with claim 6 wherein said secondary event period comprises a time duration between a start time and an end time.

8. The gaming system in accordance with claim 1, wherein said number of said gaming machines depends at least in part upon a probability of each gaming machine generating an outcome meeting said threshold wager-based game criteria.

9. The gaming system in accordance with claim 1, wherein said number of game pieces are associated with an array based upon a weighting.

10. The gaming system in accordance with claim 1, wherein said set of game pieces comprises a number of a plurality of different game pieces and said weighting depends at least in part upon a remaining number of each of said different game pieces.

11. The gaming system in accordance with claim 10, wherein said weighting further depends upon a time period during said secondary event period during which each of said different game pieces may be awarded.

12. The gaming system in accordance with claim 1 wherein said game pieces are virtual.

13. The gaming system in accordance with claim 1 wherein said game server is further configured to determine an outcome of said secondary event.
